(19) United States
(12) Patent Application Publication
(10) Pub. No.: US 2010/0328703 A1
(43) Pub. Date: Dec. 30, 2010

(54) USER-CONTROLLED COLOR DETECTION AND OPTIMIZATION DURING DOCUMENT ANALYSIS PRIOR TO PRINTING

(75) Inventor: Shane Matthew Cain, Carlsbad, CA (US)

Correspondence Address: Chen Yoshimura LLP;Attention Ying Chen, 333 W. El Camino Real, Suite 380, Sunnyvale, CA, 94087, US

(73) Assignee: KONICA MINOLTA SYSTEMS LABORATORY, INC., Huntington Beach, CA (US)

(21) Appl. No.: 12/494,047

(22) Filed: Jun. 29, 2009

(51) Int. Cl. G06F 15/00

(52) U.S. Cl. 358/1.15

(57) ABSTRACT

In a print shop system including a plurality of printers and a print shop management server which manages print jobs, an improved method is described for controlling a document color detection method for purposes of assigning documents to appropriate printers for printing. A user interface is provided for the user to specify a set of criteria for selectively forwarding the color detection task to another server or for rejecting the print job. In a first embodiment, if one or more specified criteria are met, the print shop management server forwards the print job to another server to perform color detection. In a second embodiment, if one or more specified criteria are met, the print shop management server rejects the print job and notifies the user.

### BACKGROUND OF THE INVENTION

1. Field of the Invention

This invention relates to a method and apparatus for managing print jobs in a print shop system for printing documents that contain both color and black and white pages. In particular, it relates to an improved method for detecting color components in such documents for purposes of assigning documents to appropriate printers for printing.

2. Description of Related Art

A professional print shop typically has a plurality of printers connected to a server by a network, where the server controls the printing of customer jobs on one or more printers. The printers in a print shop typically have different characteristics and capabilities. In particular, a print shop typically has both black and white printers and color printers. A conventional practice is to print documents containing only black and white (B&W) pages using black and white printers, and to print documents containing B&W as well as color pages using color printers. Here, the term B&W page includes a page with gray-level images, which can be printed on a B&W printer using black ink or toner, for example, as halftone images. Printing with a color printer is typically more costly than printing with a black and white printer.

An improved print shop management method allows a document containing B&W as well as color pages to be split into two sub-documents, one color document and one B&W document, and prints the two documents using two separate printers, one color printer and one B&W printer, respectively. In a method described in commonly owned U.S. Pat. Appl. Pub. No. 2007/0229881A1, when a document to be printed contains both color and B&W pages, the server splits the print job into a color and a B&W sub-job. Each print job includes a job ticket containing a plurality of parameters and the document to be printed. The server splits the original print job by generating a color sub-document and a B&W sub-document based the color characteristics of the pages of the original document, and generating a color sub-job ticket and a B&W sub-job ticket based on the original job-ticket parameters, by suitably retaining some original parameters, overriding some, deleting some, retaining some with page shifting, and adding some parameters. The two sub-jobs are printed by two different printers and the printed pages are then merged into one set of pages. In another method described in commonly owned U.S. Pat. Appl. Pub. No. 2008/0079963A1, to print a document having both color and B&W pages using N-up and/or duplex printing, the server determines whether to print the entire document on a color printer or to split the document into two sub-jobs and print them on a color printer and a B&W printer, respectively.

In order to determine how to assign a print job to appropriate printers, the server needs to determine whether each page of the document is a B&W page (i.e. it contains only black and white content) or whether it is a color page (i.e. it contains color content, whether or not it also contains B&W content).

### SUMMARY

The present invention is directed to an improved method and apparatus for detecting color content of a page for purpose of assigning the print job to appropriate printers.

An object of the present invention is to provide a more efficient and more flexible method for detecting color content of a page.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented on a server computer for detecting color contents in a document, which includes: (a) determining whether the document exceeds one or more pre-defined size limits, and if it does, either forwarding the document to another server or rejecting the document; (b) if the document does not exceed the one or more size limits, analyzing a page of the document to determine whether it contains color content, and maintaining a count of colored pages in the document analyzed so far; (c) determining whether the count of colored pages exceeds a pre-defined color page number limit, and if it does, either forwarding the document to the other server or rejecting the document; and (d) if the count of colored pages does not exceed the color page number limit, repeating steps (b) and (c).

In another aspect, the present invention provides a computer program product that causes a data processing apparatus to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a flow chart showing a color detection method according to an embodiment of the present invention.

FIG. 2 illustrates a user interface window for specifying various settings for a color detection process according to another embodiment of the present invention.

FIG. 3 illustrates a print shop system in which embodiments of the present invention may be implemented.

### DETAILED DESCRIPTION OF PREFERRED EMBODIMENTS

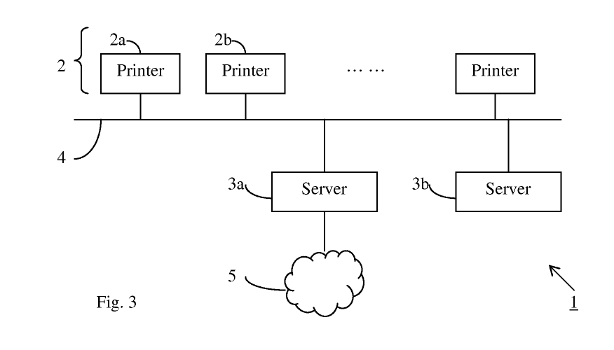

FIG. 3 schematically shows a print shop system 1 in which embodiments of the present invention may be implemented. The print shop system 1 includes a plurality of printers 2a, 2b, . . . connected to one or more servers (or any suitable data processing apparatus) 3a, 3b via a network 4. One or more user interface terminals (not shown) are also connected to the server to enable print shop operators to interact with the server and the rest of the system. The servers may also be connected to an external network 5 such as the Internet for receiving print jobs (i.e. print requests from customers and documents to be printed). The server (3a in this example), under control of print shop management software, receives print jobs from customers and submits print commands and data to be printed to one or more printers 2. The print shop management software may make various management decisions, such as which printer(s) to use for a print job, either automatically or under various degree of control of an operator.

When a document to be printed (hereinafter referred to as the source document) contains both color pages and B&W pages (referred to as a mixed color document), the server 3a makes a determination as to whether to submit the entire print job (i.e. all pages of the source document) to a color printer(s), or to split the print job into two sub-jobs by submitting the color pages to a color printer(s) and the black and white pages to a black and white printer(s). If the server 3a decides to split the print job into two sub-jobs, the server splits the print job by generating two sub-job tickets, and submits them to two different printers. The printed pages from the two printers are then combined into one printed document.

To properly process a print job, the server 3a must determine whether each page of the document is a B&W page or a color page. This information is then used in processes such as splitting the document for printing based on color, defining print job constraints, etc. In an existing color detection method, the server 3a uses a software program that parses and analyzes the source documents. The server 3a collects all vector and raster graphical data for each page and uses that information to render the page to an RGB or RGBA-based bitmap in memory. Here, RGBA stands for color components red, green, blue, and alpha (which represents opacity of the sample). Then, the R, G, and B values of each sample in the stored bitmap are examined for color. A sample is considered colored if its R, G and B values are not identical. This method has the advantage of examining all elements of the final page image. However, it tends to be computationally intensive and may affect the performance of the color detection process, especially when it involves rasterizing pages with large, embedded images (i.e. document raster source images such as .TIFF files that contain a large number of samples). The performance issue is more severe when the rasterization process is carried out by a computer (e.g. the server 3a) that is concurrently processing multiple documents of many types as well as running other services and applications.

Embodiments of the present invention provide a flexible solution for increasing document analysis efficiency by adding options to the server application that can be controlled and adjusted by a user (preferably a user with administration level privileges). In a first embodiment, the server 3a allows the user to selectively forward (or route) the color detection processing task for print jobs to another computer of the print shop system, such as server 3b in FIG. 3, for execution. The selective forwarding is done based on various criteria. In a second embodiment, the user instead of routing to an alternate computer for analysis, a print job may be rejected it the associated documents exceed limitations. These methods are implemented as a part of the print shop management software executed by the server 3a.

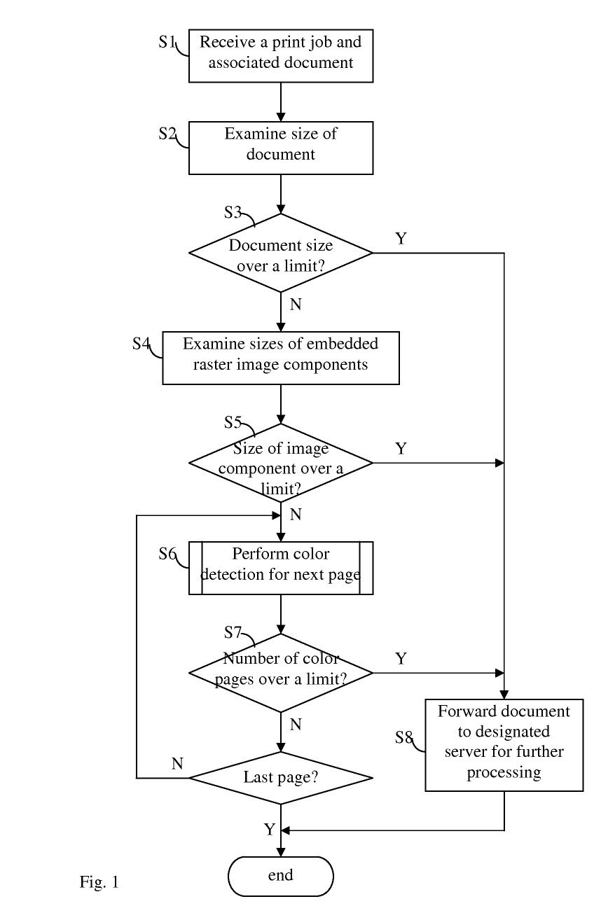

An improved color detector method according to the first embodiment of the present invention is described with reference to FIG. 1. After receiving a print job with the associated document to be printed (step S1), the server 3a first examines the size of the document (step S2). If the document size is over a pre-defined document size limit (“Y” in step S3), the server 3a forwards the print job to another designated server (e.g. server 3b) to carry out color detection (step S8). If the document size is not over the limit (“N” in step S3), the server 3a examines the sizes (e.g., width and height) of each embedded raster image component in the document to determine whether any image components exceed a pre-defined image size limit (step S4). The width and height of an image component are preferably measured in the number of horizontal and vertical samples of the image component.

If any image component exceeds the image size limit (“Y” in step S5), the server 3a forwards the print job to the other designated server 3b to carry out color detection (step S8). If no image component exceeds the limit (“N” in step S5), the server 3a proceeds to carry out a color detection process for the document, one page at a time, to determine whether the page is color or black and white (step S6). This step may be performed using the existing color detection process described earlier, i.e., by rasterizing the page and analyzing the raster image for color. Other suitable method can also be used to analyze the page for color. In step S6, the server 3a also maintains a count of color pages in the document analyzed so far.

After processing each page, the server 3a determines whether the count of color pages detected so far in this document has exceeded a pre-defined color page number limit (step S7). If it has (“Y” in step S7), the server 3a forwards the print job to the other designated server for color detection (step S8). Preferably, in this step, the server 3a notifies the other server that certain pages have already been processed. If the number of color pages does not exceed the pre-defined color page number limit (“N” in step S7), the server 3a continues the color detection process for the next page until the entire document is processed.

An improved color detector method according to the second embodiment of the present invention has a similar process flow as the first embodiment shown in FIG. 1, except that in step S8, instead of forwarding the print job to another designated server, the server 3a rejects the print job if a limit is exceeded in steps S3, S5 or S7. In the modified step S8, the server 3a will notify the user that the print job is rejected because certain limitations have been exceeded.

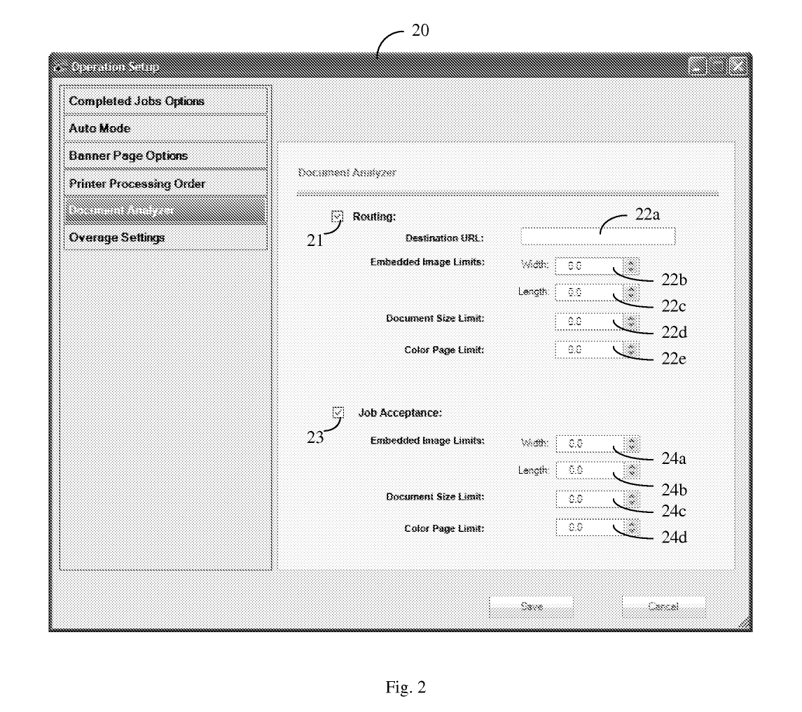

FIG. 2 illustrates a user interface (UI) window of the print shop management software of the server 3a. As shown in FIG. 2, the UI window 20 provides an input tool to allow the user to set one or more criteria for forwarding the color detection processing task to another server. In the illustrated example, the input tool includes a checkbox 21 and a number of input fields 22a-e. If the checkbox 21 is not checked, no forwarding will be done (i.e. the server 3a will perform the color detection process). If the checkbox 21 is checked, the user can further input data in the input fields 22a-e to set one or more criteria for forwarding the color detection processing task.

In the illustrated example, the criteria input fields 22a-e include a field 22a for specifying a destination server, fields 22b and 22c for an image size (width, height) limit (refer to steps S4 and S5 in FIG. 1), a field 22d for a document size limit (refer to steps S2 and S3 in FIG. 1), and a field 22e for a color page number limit (refer to step S7 in FIG. 1). For example, if the destination field 22a specifies a destination server and one or more of fields 22b-22e specify criteria values, then the server 3a will forward the color detection task to the destination server if any of the specified criteria is met, in a manner shown in FIG. 1. Any of the fields 22b-e may contain a null value (e.g. “NONE” or 0), in which case that criterion will be skipped in the decision process of FIG. 1. The value of the destination field may be, for example, the destination server's URL, IP address, name, etc.

If the destination field 22a specifies a destination server but all of the other input fields 22b-e contain null values, then the server 3a will forward the color detection process of all print jobs to the destination server, without performing the process of FIG. 1.

The fields 22a-e may be implemented in any suitable form, such as a field for typing a value, up and down arrows for increasing or decreasing the value, a drop-down lists, etc.

Further, the UI window 20 provides an input tool to allow the user to set one or more criteria for rejecting a print job. In the illustrated example, the input tool includes a checkbox 23 and a number of fields 24a-d similar to fields 22b-e. If the checkbox 23 is not checked, no print jobs will be rejected. If the checkbox 23 is checked, the user can specify one or more criteria for rejecting print jobs using fields 24a-d.

As can be seen from the above descriptions, an advantage of embodiments of the present invention is to provide the user more control over the color detection process, either by moving the process to another server or to reject documents based on certain criteria.

It will be apparent to those skilled in the art that various modification and variations can be made in the improved color detection method and apparatus of the present invention without departing from the spirit or scope of the invention. Thus, it is intended that the present invention cover modifications and variations that come within the scope of the appended claims and their equivalents.

What is claimed is:

1. A method implemented on a server computer for detecting color contents in a document, comprising:
(a) determining whether the document exceeds one or more pre-defined size limits, and if it does, either forwarding the document to another server or rejecting the document;
(b) if the document does not exceed the one or more size limits, analyzing a page of the document to determine whether it contains color content, and maintaining a count of colored pages in the document analyzed so far;
(c) determining whether the count of colored pages exceeds a pre-defined color page number limit, and if it does, either forwarding the document to the other server or rejecting the document; and
(d) if the count of colored pages does not exceed the color page number limit, repeating steps (b) and (c).

2. The method of claim 1, further comprising receiving values of the one or more pre-defined size limits from a user.

3. The method of claim 1, wherein step (a) includes:
(a1) determining whether a size of the document exceeds a pre-defined document size limit, and if it does, either forwarding the document to the other server or rejecting the document.

4. The method of claim 3, further comprising receiving values of the document size limit from a user.

5. The method of claim 1, wherein step (a) includes:
(a2) determining whether a size of any embedded raster image component of the document exceeds a pre-defined image size limit, and if it does, either forwarding the document to the other server or rejecting the document.

6. The method of claim 5, further comprising receiving values of the image size limit from a user.

7. A computer program product comprising a computer usable medium having a computer readable program code embedded therein for controlling a data processing apparatus, the computer readable program code configured to cause the data processing apparatus to execute a process for detecting color contents in a document, the process comprising:
(a) determining whether the document exceeds one or more pre-defined size limits, and if it does, either forwarding the document to another server or rejecting the document;
(b) if the document does not exceed the one or more size limits, analyzing a page of the document to determine whether it contains color content, and maintaining a count of colored pages in the document analyzed so far;
(c) determining whether the count of colored pages exceeds a pre-defined color page number limit, and if it does, either forwarding the document to the other server or rejecting the document; and
(d) if the count of colored pages does not exceed the color page number limit, repeating steps (b) and (c).

8. The computer program product of claim 7, wherein the process further comprises receiving values of the one or more pre-defined size limits from a user.

9. The computer program product of claim 7, wherein step (a) includes:
(a1) determining whether a size of the document exceeds a pre-defined document size limit, and if it does, either forwarding the document to the other server or rejecting the document.

10. The computer program product of claim 9, wherein the process further comprises receiving values of the document size limit from a user.

11. The computer program product of claim 7, wherein step (a) includes:
(a2) determining whether a size of any embedded raster image component of the document exceeds a pre-defined image size limit, and if it does, either forwarding the document to the other server or rejecting the document.

12. The computer program product of claim 11, wherein the process further comprises receiving values of the image size limit from a user.
